(19) United States
(12) Patent Application Publication
(10) Pub. No.: US 2010/0146629 A1
(43) Pub. Date: Jun. 10, 2010

(54) CONTENT PROTECTION SYSTEM COMPATIBILITY IN HOME NETWORKS

(75) Inventors: Mahfuruz Rahman, Santa Clara, CA (US); Paul Fahn, Sunnyvale, CA (US)

Correspondence Address: Beyer Law Group LLP, P.O. BOX 1687, Cupertino, CA, 95015-1687, US

(73) Assignee: Samsung Electronics Co., Ltd., Suwon City (KR)

(21) Appl. No.: 12/400,681

(22) Filed: Mar. 9, 2009

Related U.S. Application Data
(60) Provisional application No. 61/119,947, filed on Dec. 4, 2008.

(51) Int. Cl. G06F 21/00

(52) U.S. Cl. 726/26

(57) ABSTRACT

In a first embodiment of the present invention, a method for performing digital rights management (DRM) for a media item in a device in a home network is provided, the method comprising: retrieving a content directory service (CDS) item for the media item, wherein the CDS item includes a pointer to a rights token and metadata regarding a DRM Interoperability Solution (DIS); determining if the rights token must be downloaded by examining the metadata regarding the DIS; and downloading the rights token by following the pointer if it is determined that the rights token must be downloaded.

### CROSS REFERENCE TO RELATED APPLICATIONS

This patent application claims priority to U.S. Provisional Patent Application No. 61/119,947, filed on Dec. 4, 2008 (Attorney Docket No. SISAP075P/TIC08-ST09-PRO) entitled “METHODS OF ENABLING CONTENT PROTECTION SYSTEM COMPATIBILITY IN HOME NETWORKS”, by Mahfuzur RAHMAN and Paul FAHN, which is incorporated by reference in its entirety for all purposes.

### BACKGROUND OF THE INVENTION

1. Field of the Invention

The present invention relates to home networks. More particularly, the present invention relates to the enabling of content protection system compatibility in home networks.

2. Description of the Related Art

Universal Plug and Play (UPnP) is a distributed, open networking architecture that allows devices to connect seamlessly and to simplify the implementation of networks in the home (data sharing, communications, and entertainment) and corporate environments. UPnP achieves this by defining and publishing UPnP device control protocols built upon open, Internet-based communication standards.

UPnP has grown in popularity of late in part due to the rise in popularity of media servers. Media servers are small computers that store multiple types of content (e.g., photos, music, videos, etc.). The content may then be streamed from a media server to one or more control points (e.g., iPod, television set, etc.).

As an example, a “Media Server” device might contain a significant portion of the homeowner's audio, video, and still-image library. In order for the homeowner to enjoy this content, the homeowner must be able to browse the objects stored on the Media Server, select a specific one, and cause it to be “played” on an appropriate rendering device.

For maximum convenience, it is highly desirable to allow the homeowner to initiate these operations from a variety of User Interface (UI) devices. In most cases, these UI devices will either be a UI built into the rendering device, or a stand-alone UI device such as a wireless PDA or tablet. In other cases, the home network user interface device could be more remote and communicate with the home network through the Internet.

Content protection systems are designed to protect access to files or other data in a network. A common type of content protection system is Digital Rights Management (DRM), which is typically used to prohibit unauthorized copying or playback of media files. A DRM typically crates a license to bind a piece of content to a user, device, or set of devices, along with specified usage rights indicating permissions and constraints according to which the content can be consumed. Digital Living Network Alliance has a subcommittee (known as CPS) that is currently working towards providing guidelines on how to interoperate among different content protection mechanisms, which would allow a consumer to share his or her content among his or her devices, even if those devices use different Content Protection Technologies (CPTs). DLNA CPS calls such an interoperability system a DRM Interoperability Solution (DIS); one example of a DIS is Coral. The IDS, and its rights token, can typically work with multiple DRMs in a compatible fashion. One important element of some DISs is the rights token. The rights token is a policy artifact that contains DRM-agnostic information about the usage rights to which the user is entitled to consume the content; a rights token is defined by a DIS, or by a governance organization that has a license to use a DIS. A rights token is a tool to assist in content interoperability between DRMs, for example, by providing the information needed to allow a user to reacquire the content in a format defined by a second DRM.

A problem occurs when a device in the home network detects an item of protected content residing on another device, and the former device (known as the renderer) wants to play the content residing on the latter device (called the media server). The problem is that the renderer wants to decide whether it can play the content “as-is” (simply by copying or streaming the content from the media server), or if it needs to re-acquire a new version of the content or a new DRM license to the content. This is known as the content compatibility problem.

### SUMMARY OF THE INVENTION

In a first embodiment of the present invention, a method for performing digital rights management (DRM) for a media item in a device in a home network is provided, the method comprising: retrieving a content directory service (CDS) item for the media item, wherein the CDS item includes a pointer to a rights token and metadata regarding a DRM Interoperability Solution (DIS); determining if the rights token must be downloaded by examining the metadata regarding the DIS; and downloading the rights token by following the pointer if it is determined that the rights token must be downloaded.

In a second embodiment of the present invention, a method for establishing digital rights management (DRM) for a media item in a home network is provided, the method comprising: creating a content directory service (CDS) item for the media item, wherein the CDS item includes a pointer to a rights token and metadata regarding a DRM Interoperability Solution (DIS).

In a third embodiment of the present invention, a home network device is provided comprising: a processor configured to: retrieve a content directory service (CDS) item for a media item, wherein the CDS item includes a pointer to a rights token and metadata regarding a DRM Interoperability Solution (DIS); determine if the rights token must be downloaded by examining the metadata regarding the DIS; and download the rights token by following the pointer if it is determined that the rights token must be downloaded.

In a fourth embodiment of the present invention, a content directory server is provided comprising: a processor configured to: create a content directory service (CDS) item for a media item, wherein the CDS item includes a pointer to a rights token and metadata regarding a DRM Interoperability Solution (DIS).

In a fifth embodiment of the present invention, an apparatus for performing digital rights management (DRM) for a media item in a device in a home network is provided, the apparatus comprising: means for retrieving a content directory service (CDS) item for the media item, wherein the CDS item includes a pointer to a rights token and metadata regarding a DRM Interoperability Solution (DIS); means for determining if the rights token must be downloaded by examining the metadata regarding the DIS; and means for downloading the rights token by following the pointer if it is determined that the rights token must be downloaded.

In a sixth embodiment of the present invention, an apparatus for establishing digital rights management (DRM) for a media item in a home network is provided, the apparatus comprising: means for creating a content directory service (CDS) item for the media item, wherein the CDS item includes a pointer to a rights token and metadata regarding a DRM Interoperability Solution (DIS); and means for responding to requests from a home network device with content directory service items.

In a seventh embodiment of the present invention, a program storage device readable by a machine, tangibly embodying a set of computer instructions executable by the machine to perform a method for performing digital rights management (DRM) for a media item in a device in a home network is provided, the method comprising: retrieving a content directory service (CDS) item for the media item, wherein the CDS item includes a pointer to a rights token and metadata regarding a DRM Interoperability Solution (DIS); determining if the rights token must be downloaded by examining the metadata regarding the DIS; and downloading the rights token by following the pointer if it is determined that the rights token must be downloaded.

In an eighth embodiment of the present invention, a program storage device readable by a machine, tangibly embodying a set of computer instructions executable by the machine to perform a method for establishing digital rights management (DRM) for a media item in a home network is provided, the method comprising: creating a content directory service (CDS) item for the media item, wherein the CDS item includes a pointer to a rights token and metadata regarding a DRM Interoperability Solution (DIS).

### BRIEF DESCRIPTION OF THE DRAWINGS

FIG. 1 is a flow diagram illustrating a method for performing digital rights management for a media item in a device in a home network.

FIG. 2 is a flow diagram illustrating a method for establishing digital rights management for a media item in a home network in accordance with another embodiment of the present invention.

FIG. 3 is a block diagram illustrating a UPnP control point in accordance with an embodiment of the present invention.

FIG. 4 is a block diagram illustrating a UPnP content directory server in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

It should be noted that the term “home networking” as used throughout this document refers to a type of network that is commonly used in homes to connect media devices. There is no requirement, however, that this type of networking actually be used in homes, as it has equal applicability for use in businesses or other entities, or between multiple homes. As such, the term “home networking” shall not be construed as limiting any embodiments of the present invention to use in a home, and shall be interpreted as any type of local area network (LAN). For purposes of this document, the term “control point” shall be interpreted to mean any client device in a home network.

There are two aspects of the content compatibility problem that affect the current invention. The first are compatibility issues related to the CPT being used to protect the content on the media server. The second are compatibility issues not related to the CPT. Examples of CPT-related issues are the identity and version of the CPT system and the constraints imposed by the usage model. Examples of non-CPT-related issues are content encoding formats, file formats, and content resolutions.

In order to solve the content compatibility problem, the renderer can copy the content from the media server and then attempt to play it or inspect it in detail. However, the content is often quite large, and thus this approach is not satisfactory due to the large use of resources required, such as network bandwidth, processing power, and storage memory. It would be much more preferable to allow the renderer to inspect some metadata that describes the desired content and then decide whether to play the content as-is. As such, in an embodiment of the present invention, the Content Directory Services (CDS) is used on the media server to store the metadata that can be used by the renderer to solve the content compatibility problem. CDS allows the system to store and expose metadata that describes content.

CDS exposes content-related metadata to the user so that the user can browse, search for content, and select a specific piece of content to render on a specific device. This service can be used to enumerate a list of songs stored on an MP3 player, a list of still images comprising various slide-shows, a list of movies stored in a DVD Jukebox, a list of TV shows currently being broadcast, a list of songs stored in a CD Jukebox, a list of programs stored on a Personal Video Recorder, etc. Nearly any type of content can be enumerated via this CDS. However, protected content requires additional metadata that defines whether this content can be rendered by a particular user on a particular device. In an embodiment of the present invention, a solution is provided to use the CDS to enable the renderer to inspect the DIS-related metadata, such as a rights token, in an efficient and interoperable manner.

In an embodiment of the present invention, three mechanisms are used. The first is a pointer or index indicating the location of the rights token is placed in a newly defined, standardized location in the CDS. An example of such a pointer is a Uniform Resource Identifier (URI). This allows the renderer to obtain the entire rights token by following the URI. The second is that certain information elements that are contained in the rights token are placed in newly defined, standardized locations in the CDS. This allows the renderer to obtain and inspect these information elements, without the extra step of following the URI to the entire rights token. Examples include ContentID and UsageModelID. The third is that certain other information elements related to DIS (and thus potentially important to solving the content compatibility problem despite not being contained in the rights token) are placed in newly defined, standardized locations in the CDS. This allows the renderer to obtain and inspect these information elements. Examples include DomainManagerURI and RightsLockerURI.

In an embodiment of the present invention, methods to store and expose DIS-related metadata are defined by adding additional DRM parameters at the <res> element level of a CDS item, which basically represents a piece of content. The <res> indicates a resource, typically a media file, associated with the object. If the value of the <res> property is not present, then the content has not yet been fully imported by the ContentDirectory service and is not yet accessible for playback purposes. In an embodiment of the present invention, a new property is defined for the <res> element. This new property includes the rights token information including the URI pointing to the full content of the rights token.

In an embodiment of the present invention, the new property is defined as follows:

```
res@DLNA:X_DISInfo
Namespace: DIDL-Lite
Property Data Type: xsd:string
Multi-valued: NO
<DISInfo>
    <RightsTokenURI></RightsTokenURI>
    <EcosystemID></EcosystemID>
    <CPT-ID></CPT-ID>
    <ContentID></ContentID>
    <EcosystemAccountID></EcosystemAccountID>
    <NativeDomainID></NativeDomainID>
    <DomainManagerURI></DomainManagerURI>
    <RightsLockerURI></RightsLockerURI>
    <UsageModelID></UsageModelID>
    <ParentalControlCode></ParentalControlCode>
    <OtherDISInfo></OtherDISInfo>
</DISInfo>
```

Besides including the URI for the rights token, the above XML fragment also includes some key information related to the DIS that most renderers can use to determine whether the content can be consumed as-is. Some of these elements may already be included in the rights token. Depending on the DIS, some of these elements will be empty.

The <RightsTokenURI> element points to the location where the rights token will reside. The location could either be local (on the same device or even within the same CDS entry) or remote (on another device or server).

The <EcosystemID> element contains a global identifier for the Ecosystem (governing body) whose rules and policies determine the usages permitted for content. In some cases, the value of this element will be needed in order to correctly process the values of the other elements in <DISInfo>, such as UsageModelID.

The <CPD-ID> element contains an identifier for the content protection technology currently protecting the content on the media server, such as a DRM or a link protection technology. This identifier may be defined by the Ecosystem or defined globally. The CPT, when a DRM, is sometimes referred to as a “native” DRM.

The <ContentID> element contains an identifier to uniquely define the piece of content using an Ecosystem-defined (or Ecosystem-referenced) scheme. Ecosystem-referenced schemes includes one where the Ecosystem merely points to a content identification system maintained by another industry organization.

The <EcosystemAccountID> element contains an identifier for the Ecosystem Account to which the content is bound. This will affect the ability of some content to be accessed by some renderers. In some Ecosystems, the AccountID may be called a “DomainID”.

The <NativeDomainID> element contains an identification for the domain managed by the native DRM (if any). Such an identification is determined by the DRM or CPT.

The <RightsLockerURI> element contains a URI to the rights locker, which is a DIS-defined server that contains information about all the current content rights (typically in the form of rights tokens) bound to the Ecosystem account.

The <DomainManagerURI> element contains a URI to the domain manager, which is a service that manages the native DRM domain or the Ecosystem Account (or both), including keeping track of the current users and/or devices associated with that account.

The <UsageModelID> element contains an identifier for the usage rights under which the account elements can consume the content. Such usage models are typically defined by the Ecosystem.

The <ParentalControlCode> contains an identifier that indicates ratings or usage limitations for the content related to the appropriateness of the content for particular family members.

The <OtherDISInfo> element is an undefined string that can be used in accordance with DIS-specific information elements not otherwise defined in the above elements.

An example of the <res> element with DISInfo is as follows:

```
<res
protocolInfo=”http:*audio/mp3:*”
importUri=http://10.0.0.1/postdir?ide=10
DLNA:X_DISInfo=”<DISInfo>
            <RightsTokenURI></RightsTokenURI>
            <ContentID></ContentID>
            <EcosystemID></EcosystemID>
            <NativeDomainID></NativeDomainID>
            <DomainManagerURI></DomainManagerURI>
            <RightsLockerURI></RightsLockerURI>
            <UsageModelID></UsageModelID>
        </DISInfo>
    http://10.0.0.1/contentdir?id=10
</res>
```

Embodiments are possible wherein each <res> element is associated with a single version. This creates a system wherein multiple versions for the same basic media item may be maintained, with different protection systems and/or usage rights for each version. For example, the DRM for a particular movie could be different based upon whether the user is attempting to play a high-resolution version of the movie on a television or a low-resolution version of the movie on a cell phone.

In an alternative embodiment of the present invention, the DIS fields and pointer are placed at the item level rather than the <res> level, thus associating the information with the piece of content without differentiating between different versions that are contained in the same CDS item.

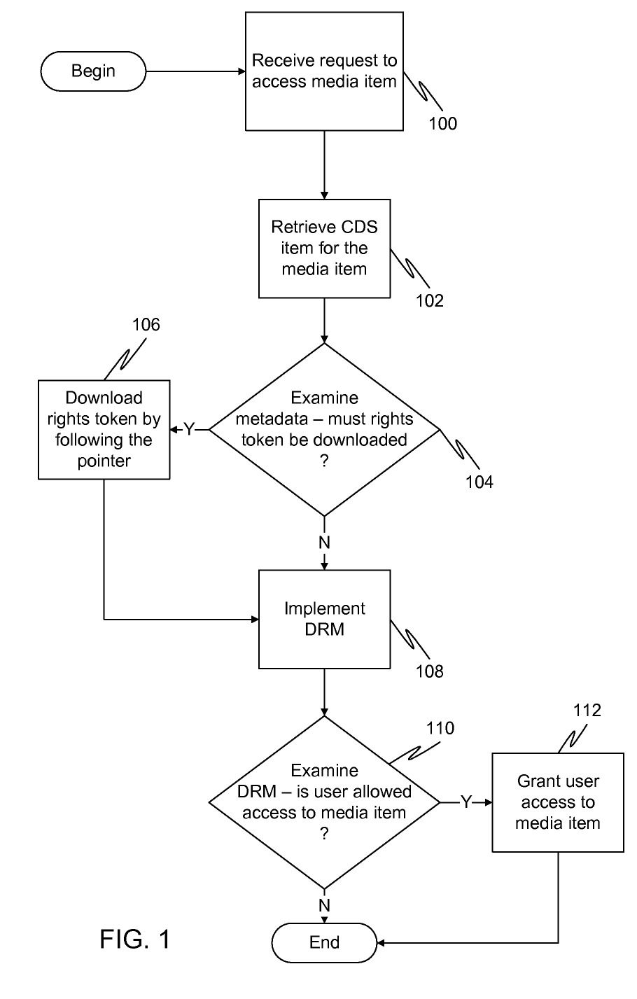

FIG. 1 is a flow diagram illustrating a method for performing digital rights management for a media item in a device in a home network. The method may be performed in the home network device, such as a control point. The method may be performed at any time, but in one embodiment is performed at the time of or just before a user requests that the media item be played, copied, or otherwise accessed.

At 100, a control point receives a request to access a media item. At 102, a content directory service item is retrieved for the media item. The content directory service item includes a pointer to a rights token and metadata regarding a DIS. At 104, it is determined if the rights token must be downloaded by examining the metadata regarding the DIS. If so, then at 106, the rights token is downloaded by following the pointer. At 108, DRM is implemented using a rights token (either the newly downloaded rights token or a previously downloaded rights token that it was determined did not need to be updated). At 110, it is determined whether or not the user access the media item based on the implemented DRM. If so, then at 112, the user accesses the media item.

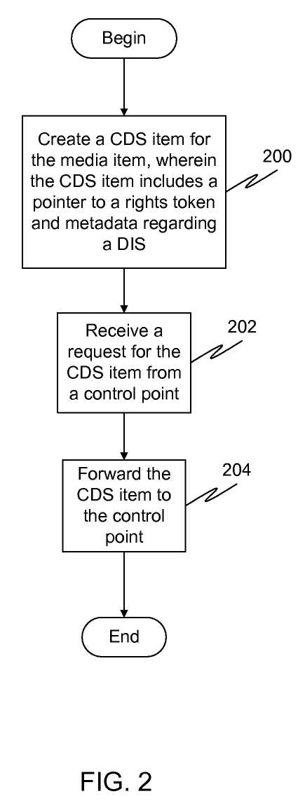

FIG. 2 is a flow diagram illustrating a method for establishing digital rights management for a media item in a home network in accordance with another embodiment of the present invention. This method may be implemented on a content directory server or other CDS provider. At 200, the CDS creates a CDS item for the media item, wherein the CDS item includes a pointer to a rights token and metadata regarding a DIS. At 202, a request for the CDS item is received from a control point. At 204, the CDS item is forwarded to the control point.

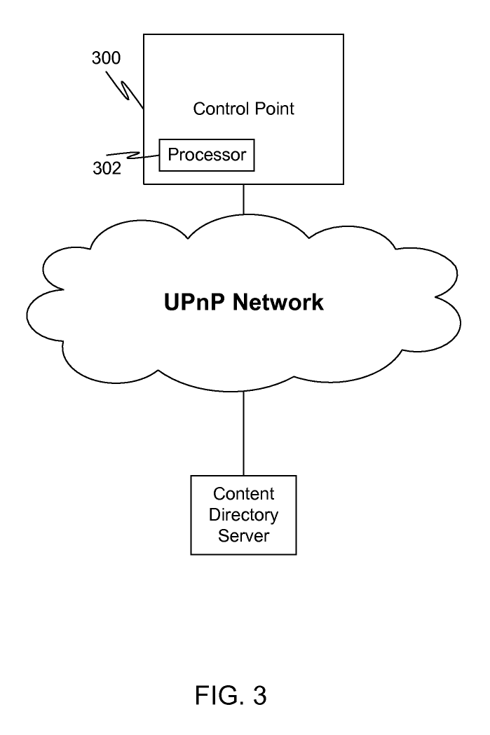

FIG. 3 is a block diagram illustrating a UPnP control point in accordance with an embodiment of the present invention. The control point may be a variety of different hardware devices, including, but not limited to, a cell phone, computer, or television. The control point may be located on the rendering device, or on a separate device in the UPnP network. The control point 300 includes a processor configured to perform the method of FIG. 1 and the corresponding text. Various specific steps in the method may be executed by specialized software modules stored in memory.

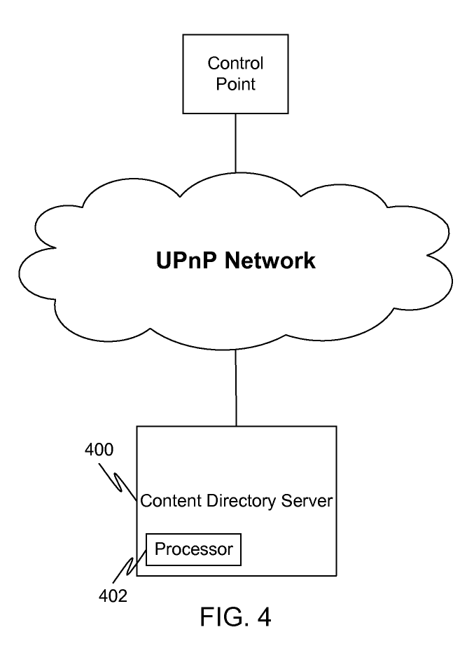

FIG. 4 is a block diagram illustrating a UPnP content directory server in accordance with an embodiment of the present invention. The content directory server may be implemented on a variety of different hardware devices, including, but not limited to, a personal computer. The Content Directory Server 400 includes a processor configured to perform the method of FIG. 2 and the corresponding text. Various specific steps in the method may be executed by specialized software modules stored in memory.

What is claimed is:

1. A method for performing digital rights management (DRM) for a media item in a device in a home network, the method comprising:
retrieving a content directory service (CDS) item for the media item, wherein the CDS item includes a pointer to a rights token and metadata regarding a DRM Interoperability Solution (DIS);
determining if the rights token must be downloaded by examining the metadata regarding the DIS; and
downloading the rights token by following the pointer if it is determined that the rights token must be downloaded.

2. The method of claim 1, wherein the CDS item includes a <res> element with a property including the metadata and pointer.

3. The method of claim 2, wherein the pointer is defined by a rights token URI in the <res> element.

4. The method of claim 2, wherein the metadata includes a global identifier for an ecosystem whose rules and policies determine the usages permitted for the media item.

5. The method of claim 2, wherein the metadata includes an identifier for content protection technology currently protecting the content on a media server.

6. The method of claim 2, wherein the metadata includes an identifier to uniquely define the media item using an ecosystem-defined or ecosystem-referenced scheme.

7. The method of claim 2, wherein the metadata includes an identifier for a ecosystem account to which the media item is bound.

8. The method of claim 2, wherein the metadata includes an identification for a domain managed by a native DRM.

9. The method of claim 2, wherein the metadata contains a pointer to a rights locker.

10. The method of claim 2, wherein the metadata includes a pointer to a domain manager.

11. The method of claim 2, wherein the metadata includes an identifier or set of parameters for usage rights under which account elements can consume the media item.

12. The method of claim 2, wherein the metadata includes an identifier that indicates content ratings for the media item that are related to the appropriateness of the media item for various user types.

13. The method of claim 1, wherein the home network is a Universal Plug and Play (UPnP) network

14. A method for establishing digital rights management (DRM) for a media item in a home network, the method comprising:
creating a content directory service (CDS) item for the media item, wherein the CDS item includes a pointer to a rights token and metadata regarding a DRM Interoperability Solution (DIS).

15. A home network device comprising:
a processor configured to:
retrieve a content directory service (CDS) item for a media item, wherein the CDS item includes a pointer to a rights token and metadata regarding a DRM Interoperability Solution (DIS);
determine if the rights token must be downloaded by examining the metadata regarding the DIS; and
download the rights token by following the pointer if it is determined that the rights token must be downloaded.

16. A content directory server comprising:
a processor configured to:
create a content directory service (CDS) item for a media item, wherein the CDS item includes a pointer to a rights token and metadata regarding a DRM Interoperability Solution (DIS).

17. An apparatus for performing digital rights management (DRM) for a media item in a device in a home network, the apparatus comprising:
means for retrieving a content directory service (CDS) item for the media item, wherein the CDS item includes a pointer to a rights token and metadata regarding a DRM Interoperability Solution (DIS);
means for determining if the rights token must be downloaded by examining the metadata regarding the DIS; and
means for downloading the rights token by following the pointer if it is determined that the rights token must be downloaded.

18. An apparatus for establishing digital rights management (DRM) for a media item in a home network, the apparatus comprising:
means for creating a content directory service (CDS) item for the media item, wherein the CDS item includes a pointer to a rights token and metadata regarding a DRM Interoperability Solution (DIS); and
means for responding to requests from a home network device with content directory service items.

19. A program storage device readable by a machine, tangibly embodying a set of computer instructions executable by the machine to perform a method for performing digital rights management (DRM) for a media item in a device in a home network, the method comprising:
retrieving a content directory service (CDS) item for the media item, wherein the CDS item includes a pointer to a rights token and metadata regarding a DRM Interoperability Solution (DIS);
determining if the rights token must be downloaded by examining the metadata regarding the DIS; and
downloading the rights token by following the pointer if it is determined that the rights token must be downloaded.

20. A program storage device readable by a machine, tangibly embodying a set of computer instructions executable by the machine to perform a method for establishing digital rights management (DRM) for a media item in a home network, the method comprising:
creating a content directory service (CDS) item for the media item, wherein the CDS item includes a pointer to a rights token and metadata regarding a DRM Interoperability Solution (DIS).
